(19) United States
(12) Patent Application Publication
(10) Pub. No.: US 2004/0263498 A1
(43) Pub. Date: Dec. 30, 2004

(54) METHOD FOR MANUFACTURE OF A POLYSILICON THIN FILM TRANSISTOR LIQUID CRYSTAL DISPLAY

(76) Inventor: Chien-Sheng Yang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,077

(22) Filed: Sep. 7, 2003

(30) Foreign Application Priority Data
Jun. 25, 2003 (TW) 092117315

(51) Int. Cl. G09G 5/00

(52) U.S. Cl. 345/204

(57) ABSTRACT

A polysilicon TFT LCD includes a panel, a plurality of display cells, a timing control circuit for generating a timing signal, and a plurality of logic circuits for controlling operations of the display cells according to the timing signal. The method determines a location in the panel for forming the timing control circuit to make the differences among delays ofthe time intervals of the timing signal transmitted to the logic circuits less than 1000 μs.

### BACKGROUND OF INVENTION

1. Field of the Invention

The present invention relates to a method for manufacture of a polysilicon thin film transistor liquid crystal display, and more particularly, to a method for improving display qualities by determining the location of the timing control circuit.

2. Description of the Prior Art

Liquid crystal displays (LCDs) have been widely applied to a variety of information products, such as notebook computers and PDAs, because of their small size, low power consumption, and low radiation emissions. Liquid crystal molecules are characterized by being capable of allowing different amounts of light to pass according to their rotation angles. Consequently, a liquid crystal display is able to generate rich and colorful images.

At present, LCDs are primarily classified as two types: amorphous silicon thin film transistor liquid crystal displays (a-TFT LCDs) and polysilicon thin film transistor liquid crystal displays (polysilicon TFT LCDs). Polysilicon TFT LCDs are generally used in high quality displays because of their better display characteristics. Conventionally, the driving circuit of polysilicon TFT LCD is an IC connected to an LCD panel. As improvements are made in semiconductor technology, however, the driving circuit and the interface circuit are integrated in the form of thin film transistors in the LCD panel such that the production cost is substantially reduced.

Generally speaking, the above-mentioned integrated polysilicon TFT LCD comprises a timing control circuit for controlling operations of various logic circuits. However, the location of the timing control circuit of the conventional polysilicon TFT LCD is not optimal, and thus, display quality deteriorates easily due to clock skew. Refer to FIG. 1, which is a schematic diagram of a conventional polysilicon TFT LCD 10. The polysilicon TFT LCD 10 comprises a panel 12, a display region 14, a first data line driving circuit 16A, a second data line circuit 16B, a scan line driving circuit 18, a common electrode driving circuit 20, a timing control circuit 22, an interface circuit 24, and a connecting component 26. The display region 14, the first data line driving circuit 16A, the second data line driving circuit 16B, the scan line driving circuit 18, the common electrode driving circuit 20, the timing control circuit 22, and the interface circuit 24 are formed in the panel 12 in the form of thin film transistors, while the connecting component 26 is connected to the panel 12.

As shown in FIG. 1, An image signal Si is transmitted to the polysilicon TFT LCD 10 via the connecting component 26 and transferred to related logic circuits by the interface circuit 24, such that the display region 14 can display the images corresponding to the image signal Si. The display region 14 comprises a plurality of display cells, each display cell including a pixel or a sub-pixel. The first data line driving circuit 16A, the second data line driving circuit 16B, and the scan line driving circuit 18 drive the display cells. In addition, the common electrode driving circuit 20 is used for providing a common voltage for increasing the update speed of the display region 14, and the timing control signal 22 is used for generating a timing signal SA. The first data line driving circuit 16A, the second data line driving circuit 16B, the scan line driving circuit 18, and the interface circuit 20 are operated according to the timing signal SA. Nevertheless, the location of the timing control circuit 22 in the panel 12 is not optimized, thus the display quality of the polysilicon TFT LCD is deteriorated easily because of clock skew.

Refer to FIG. 1 and FIG. 2. FIG. 2 is a timing diagram illustrating the timing signal SA of the polysilicon TFT LCD shown in FIG. 1. FIG. 2 illustrates the waveform of the timing signal SA in the timing control circuit 22, the first data line driving circuit 16A, and the second data line driving circuit 16B, respectively from top to bottom. As shown in FIG. 1, the timing signal SA is transmitted to the first data line driving circuit 16A via the first transmitting line 28A, and to the second data line driving circuit 16B via the second transmitting line 28B. However, since the first transmitting line 28A is longer than the second transmitting line 28B, consequently as shown in FIG. 2 the delay time T1 of the timing signal transmitted to the first data line driving circuit 16A differs from the delay time T2 of the timing signal transmitted to the second data line driving circuit 16B. When the difference between T1 and T2 is more than a tolerable interval, unstable and undesirable display effects (such as screen flicker) could occur.

### SUMMARY OF INVENTION

It is therefore an object of the present invention to provide a layout method of a polysilicon thin film transistor liquid crystal display for solving the above-mentioned problem.

According to the present invention, a layout method for a polysilicon thin film transistor liquid crystal display is disclosed. The polysilicon TFT LCD comprises a panel, a plurality of display cells, a timing control circuit for generating a timing signal, and a plurality of logic circuits. The display cells, the timing control circuit, and the logic circuits are formed in the panel, wherein the logic circuits control operations of the display cells according to the timing signal. The method of the present invention makes the differences among the delay time intervals of the timing signals transmitted to each logic circuit less than 1000 μs by determining the location of the timing control circuit.

It is an advantage of the present invention that the display quality of the polysilicon TFT LCD is effectively improved.

These and other objects of the present invention will beapparent to those of ordinary skill in the art after having read the following detailed description of the preferred embodiment that is illustrated in the various figures and drawings.

### BRIEF DESCRIPTION OF DRAWINGS

FIG. 1 is a schematic diagram of a conventional polysilicon TFT LCD.

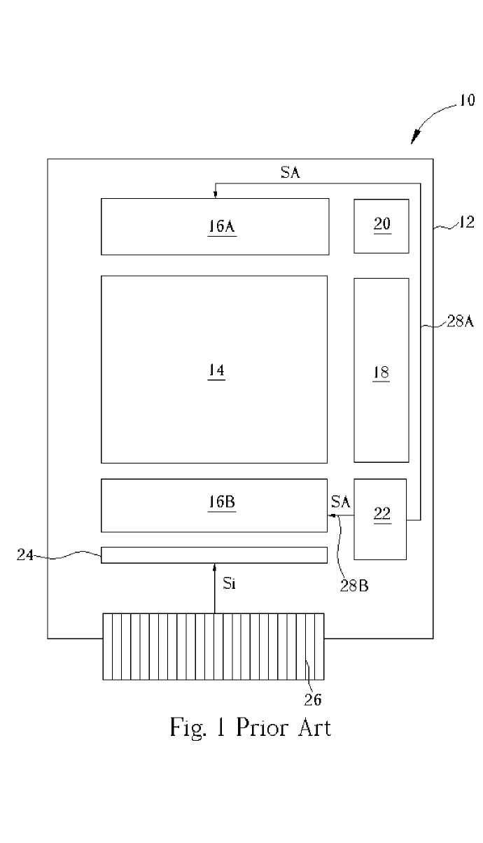

FIG. 2 is a timing diagram illustrating timing signals of the polysilicon TFT LCD shown in FIG. 1.

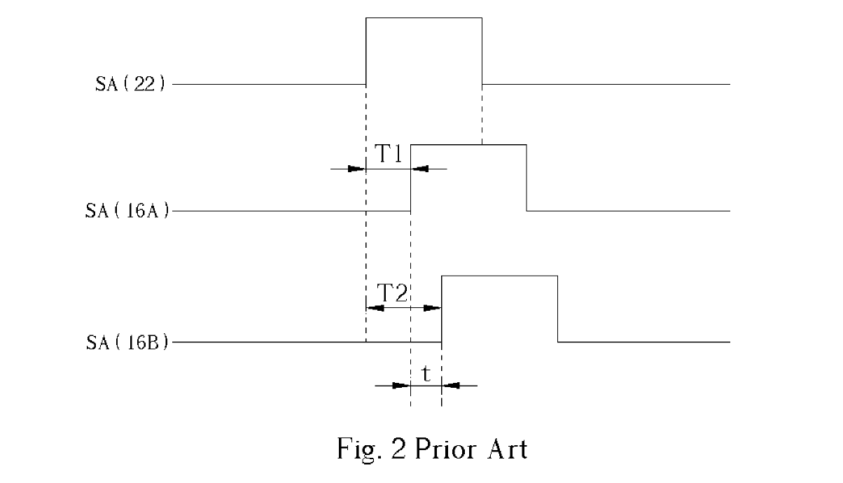

FIG. 3 is a schematic diagram of a polysilicon TFT LCD of the present invention.

FIG. 4 is a circuit diagram of a display region of the polysilicon TFT LCD shown in FIG. 3.

FIG. 5 is a timing diagram illustrating timing signals of the polysilicon TFT LCD shown in FIG. 3.

### DETAILED DESCRIPTION

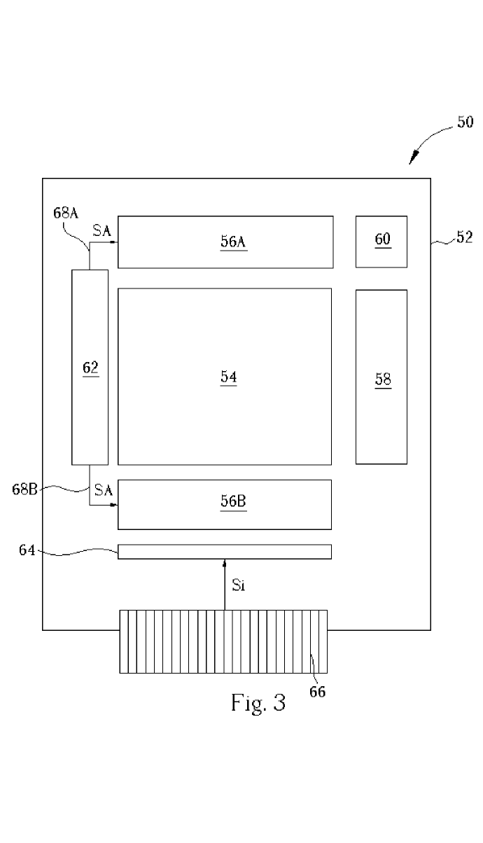

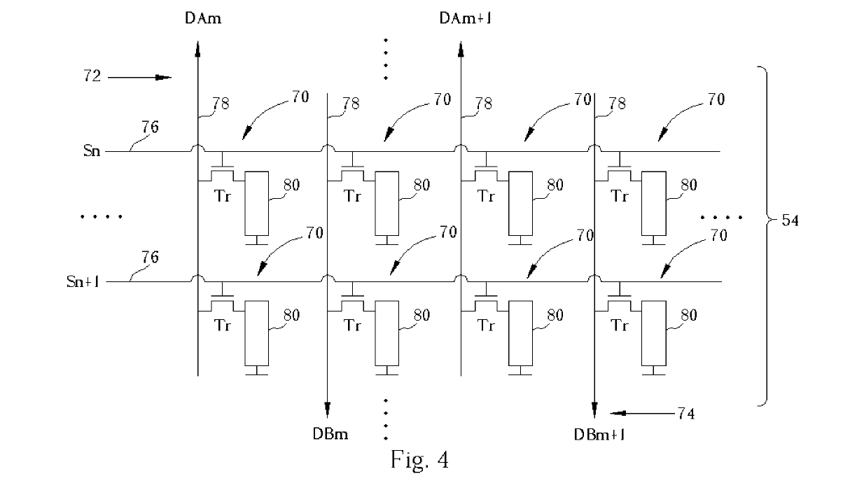

Refer to FIG. 3 and FIG. 4. FIG. 3 is a schematic diagram of a polysilicon TFT LCD 50 of the present invention. FIG. 4 is a circuit diagram of a display region of the polysilicon TFT LCD 50 shown in FIG. 3. Similar to the conventional polysilicon TFT LCD 10, the polysilicon TFT LCD comprises a panel 52, wherein related logic circuits and interface circuits are formed in the panel 52. The polysilicon TFT LCD further comprises a display region 54, a first data line driving circuit 56A, a second data line driving circuit 56B, a scan line driving circuit 58, a common electrode driving circuit 60, a timing control circuit 62, an interface circuit 64, and a connecting component 66. The display region 54, the first data line driving circuit 56A, the second data line driving circuit 56B, the scan line driving circuit 58, the common electrode driving circuit 60, the timing control circuit 62, and the interface circuit 64 are formed in the panel 52 in the form of thin film transistors, while the connecting component 66 is connected to the panel 52.

An image signal Si is transmitted to the polysilicon TFT LCD 50 via the connecting component 66, and transferred to related logic circuits via the interface circuit 64, such that the display region 54 can display the images corresponding to the image signal Si. As shown in FIG. 4, the display region 54 comprises a plurality of display cells 70, each display cell 70 having a pixel or a sub-pixel. Each display cell 70 comprises a polysilicon TFT Tr and a liquid crystal component 80, wherein the liquid crystal component 80 varies its image characteristic under the control of the polysilicon TFT Tr. In addition, the polysilicon TFT LCD further comprises a plurality of scan lines 76 and data lines 78 connected to the display cells 70. The data lines 78 are divided into a first group 72 and a second group 74, wherein the data lines 78 of the first group 72 are connected to the first data line driving circuit 56A, and the data lines 78 of the second group 74, which are arranged alternately to the data lines 78 of the first group 72, are connected to the second data line driving circuit 56B. As shown in FIG. 4, data lines DAm and DAm+1 belong to the first group 72, while data lines DBm and DBm+1 belong to the second group 74. In addition, the scan lines 76 are connected to the scan line driving circuit 58, wherein the scan line driving circuit 58 can turn on the polysilicon TFT Tr via the scan lines 76. Therefore, when the polysilicon TFT Tr is turned on, the liquid crystal component 80 of the display cells 70 changes its corresponding display characteristic according to the voltage of the data lines 78. Furthermore, the common electrode driving circuit 70 is for increasing the update speed of the display cells 70, and the timing control circuit 62 is for generating a timing signal SA, wherein the first data line driving circuit 56A, the second data line driving circuit 56B, the scan line driving circuit 58, and the interface circuit 64 operates according to the timing signal SA.

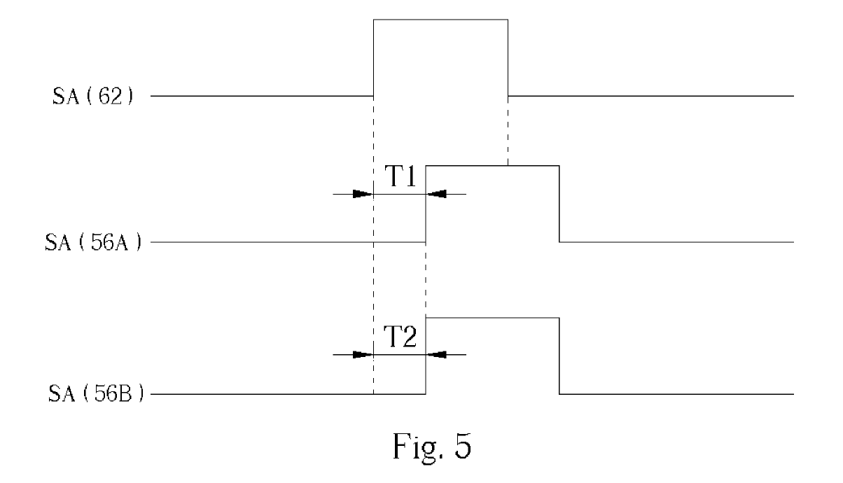

A key difference of the polysilicon TFT LCD 50 compared to the conventional polysilicon TFT LCD 10 is that the location of the timing control circuit 62 in the panel 52 is determined after accurate calculation, such that the differences among the delay time intervals of the timing signals transmitted to each logic circuit is less than a certain value. In order to comply with high display quality requirements, this specific value is set as 1000 μs. Specifically, refer to FIG. 3 and FIG. 5. FIG. 5 is a timing diagram illustrating timing signals of the polysilicon TFT LCD shown in FIG. 3. FIG. 5 illustrates the waveform of the timing signal SA in the timing control circuit 62, the first data line driving circuit 56A, and the second data line driving circuit 56B, respectively from top to bottom. As shown in FIG. 3, the timing control circuit 62 is positioned between the first data line driving circuit 56A and the second data line driving circuit 56B, and respectively connected to the first data line driving circuit 56A and the second data line driving circuit 56B via a first transmitting line 68A and a second transmitting line 68B. The lengths of the first transmitting line 68A and the second transmitting line 68B are equal. As shown in FIG. 5, the delay time T1 of the timing signal SA transmitted to the first data line driving circuit 56A and the delay time T2 of the timing signal SA transmitted to the second data line driving circuit 56B are nearly equal. Hence, the polysilicon TFT LCD 50 of the present invention is more stable than the conventional polysilicon TFT LCD 10.

It is worth noting that the delay of the timing signal SA results from the resistance of the transmitting line (such as the transmitting lines 68A and 68B), and the parasitic capacitance of these transmitting lines. Therefore, the delay time is referred to as the product of the equivalent resistance and the equivalent capacitance. In other words, the unit of the delay time is second (s), which equals the product of the resistance unit “ohm” and the capacitance unit “farad”. Hence, when the differences of delay times among different transmitting lines (such as the transmitting lines 68A and 68B) are less than 1000 μs, the display quality is not deteriorated. In addition, the delay time can also be determined by adjusting the equivalent resistance value and the equivalent capacitance value of the transmitting lines.

In comparison with the conventional polysilicon TFT LCD, the location of the timing control circuit is determined, such that differences in delay time among different logic circuits are less than a predetermined value (such as 1000 μs). Consequently, the display quality is effectively improved.

Those skilled in the art will readily appreciate that numerous modifications and alterations of the device may be made without departing from the scope of the present invention. Accordingly, the above disclosure should be construed as limited only by the metes and bounds of the appended claims.

What is claimed is:

1. A method for manufacturing a polysilicon thin film transistor liquid crystal display, the polysilicon thin film liquid crystal display comprising:
a panel;
a plurality of display cells, each display cell having at least a polysilicon thin film transistor;
a timing control circuit for generating a timing signal;
and
a plurality of logic circuits for controlling operations of the display cells according to the timing signal;
the method comprising:
forming the plurality of display cells in the panel;
forming the plurality of logic circuits in the panel; and
determining a location in the panel for forming the timing control circuit so as to make differences among delay time intervals of the timing signals transmitted to the logic circuits less than 1000 μs, and forming the timing control circuit accordingly.

2. The method of claim 1 wherein the timing signal is transmitted to the logic circuits by a plurality of transmitting lines, and differences between a product of an equivalent resistance value and an equivalent capacitance value of each transmitting line are less than 1000 μs.

3. The method of claim 1 wherein the polysilicon thin film transistor further comprises a plurality of scan lines and data lines connected to the display cells, and the plurality of logic circuits further comprise:
a scan line driving circuit connected to the plurality of scan lines;
a first data line driving circuit connected to the data lines of a first group; and
a second data line driving circuit connected to the data lines of a second group, the data lines of the first group and the data lines of the second group being arranged alternately.

4. The method of claim 3 wherein the timing signal is respectively transmitted to the first data line driving circuit and to the second data line driving circuit by a first transmitting line and a second transmitting line, differences between a product of an equivalent resistance value and an equivalent capacitance value of the first transmitting line and a product of an equivalent resistance value and an equivalent capacitance value of the second transmitting line being less than 1000 μs.

5. The method of claim 1 wherein the polysilicon thin film liquid crystal display further comprises an interface circuit for receiving and transmitting an image signal such that the display cells operate according to the image signal.
